(19) United States
(12) Patent Application Publication
(10) Pub. No.: US 2009/0049334 A1
(43) Pub. Date: Feb. 19, 2009

(54) Method and Apparatus to Harden an Internal Non-Volatile Data Function for Sector Size Conversion

(76) Inventors: John Charles Elliott, Tucson, AZ (US); Robert Akira Kubo, Tucson, AZ (US); Gregg Steven Lucas, Tucson, AZ (US)

Correspondence Address: IBM CORP. (WIP);c/o WALDER INTELLECTUAL PROPERTY LAW, P.C., 17330 PRESTON ROAD, SUITE 100B, DALLAS, TX, 75252, US

(21) Appl. No.: 11/838,406

(22) Filed: Aug. 14, 2007

(51) Int. Cl. G06F 11/16; G06F 12/16

(52) U.S. Cl. 714/5; 711/112; 711/E12.103; 714/E11.054

(57) ABSTRACT

A sector conversion device includes a non-volatile memory area that is used to save two sectors' worth of data when power is lost during the sector conversion process. These two sectors of data are stored in the non-volatile memory area within the sector conversion device itself. The non-volatile memory within the sector conversion device is connected to the main internal memory of the device by a special link that is wider than the normal word size of the buffer. When power is lost to the storage enclosure during a scenario where data is being written to the hard disk drives, which involves sector conversion, the internal processor of the sector conversion device immediately initiates a transfer from the volatile buffer queue memory to the non-volatile memory. The information that is transferred (hardened) is the two sectors of data that were involved in the sector conversion process.

### BACKGROUND

1. Technical Field

The present application relates generally to an improved sector size conversion device for a storage enclosure. More specifically, the present application is directed to a method and apparatus to harden an internal non-volatile data function for sector size conversion.

2. Description of Related Art

Storage systems using hard disk drives (HDDs) must format data according to the sector size defined by the hard disk drive manufacturer. A sector is the smallest unit of data written to or read from a hard disk. A typical sector size for hard disk drives is 512 bytes.

Many storage systems require additional metadata to be appended to each sector's worth of data, resulting in non-standard sector size from the hard disk drive's perspective. For example, a storage system may add cyclical redundancy checking (CRC) data, which is an error checking technique used to ensure the accuracy of the data. Several product environments require different sector sizes. For example Fibre Channel (FC) to Serial Advanced Technology Attachment (SATA) enclosures and other high performance enclosures may require up to 4 KB sectors.

A sector conversion device converts the sector size of data to the sector size of the hard disk drives before writing the data to disk. The sector conversion device may be provided on an application specific integrated circuit (ASIC). However, whenever sector conversion is employed, there exist some data integrity exposures when power is lost to the storage enclosure during writes to the hard disk drives.

A current solution is to provide within the sector conversion ASIC an interface to an external non-volatile memory, such as an electrically erasable programmable read-only memory (EEPROM) or flash memory. The sector conversion ASIC must store at least two sectors of data to the external non-volatile memory, one sector that is currently “in flight” to the HDD at the time of power loss and a subsequent sector that is in flight. However, a higher speed of the external non-volatile memory is required due to the constrained hold-up time once power is lost. Furthermore, the interface to an external memory adds complexity and cost to the sector conversion ASIC.

### SUMMARY

The illustrative embodiments recognize the disadvantages of the prior art and provide a sector conversion device that includes a non-volatile memory area that is used to save two sectors' worth of data when power is lost during the sector conversion process. As part of the sector conversion process, the sector conversion device transfers two sectors of data from a volatile buffer queue memory to a non-volatile memory when a power loss event occurs. These two sectors of data are stored in the non-volatile memory area within the sector conversion device itself. The non-volatile memory within the sector conversion device is connected to the main internal memory of the device by a special link that is wider than the normal word size of the buffer.

When AC power is lost to the storage enclosure during a scenario where data is being written to the hard disk drives, which involves sector conversion, the internal processor of the sector conversion device immediately initiates a transfer from the volatile buffer queue memory to the non-volatile memory and quiesces all subsequent write activity. The information that is transferred (hardened) is the two sectors of data that were involved in the sector conversion process. Because of the width of the special link, the transfer is very fast, which reduces or altogether eliminates any special hold-up capacitance requirements.

In one illustrative embodiment, a computer program product comprises a computer useable medium having a computer readable program. The computer readable program, when executed on a computing device, causes a sector conversion device to receive sector data and responsive to a power loss event from a voltage source, initiate a transfer of an amount of the received sector data from a buffer queue memory to a non-volatile memory that is internal to the sector conversion device.

In one exemplary embodiment, the amount of the received sector data is two sectors. In another exemplary embodiment, the power loss event is an early power off warning.

In still another exemplary embodiment, the computer readable program, when executed on the computing device, further causes the sector conversion device to convert the sector data to a sector size of at least one hard disk drive to form converted sector data and output the converted sector data to at least one hard disk drive. In a further exemplary embodiment, the non-volatile memory is connected to the buffer queue memory by a wide bus.

In one illustrative embodiment, a sector conversion device comprises a processor, a buffer queue memory, and a non-volatile memory. The processor receives sector data and stores the received sector data into the buffer queue memory. Responsive to a power loss event from a voltage source, the processor initiates a transfer of an amount of the received sector data from the buffer queue memory to the non-volatile memory.

In one exemplary embodiment, the buffer queue memory is a volatile memory. In another exemplary embodiment, the amount of sector data is two sectors. In a further exemplary embodiment, the non-volatile memory is connected to the buffer queue memory by a wide bus.

In another exemplary embodiment, the power loss event is an early power off warning. In a further exemplary embodiment, the early power off warning is an interrupt.

In still another exemplary embodiment, the sector conversion device is an application specific integrated circuit. In a further exemplary embodiment, the processor converts the sector data to a sector size of at least one hard disk drive to form converted sector data and outputs the converted sector data to the at least one hard disk drive.

In a still further exemplary embodiment, the sector conversion device is associated with a storage controller. The processor receives sector data from the storage controller. The processor converts the sector data from a first sector size to a second sector size to form converted sector data. The processor sends the converted sector data to a switch to be written to one of a plurality of hard disk drives.

In another exemplary embodiment, the sector conversion device is associated with a hard disk drive. The processor receives sector data from a switch. The processor converts the sector data from a first sector size to a second sector size to form converted sector data. The processor sends the converted sector data to the hard disk drive.

In still another illustrative embodiment, a method for internal sector storage in a sector conversion device comprises receiving sector data, converting the sector data to a sector size of at least one hard disk drive to form converted sector data, outputting the converted sector data to the at least one hard disk drive, and responsive to a power loss event from a main voltage source, initiating transfer of an amount of the received sector data from a buffer queue to a non-volatile memory that is internal to the sector conversion device.

In one exemplary embodiment, the amount of the received sector data is two sectors.

In another exemplary embodiment, the power loss event is an early power off warning. In a further exemplary embodiment, the early power off warning is an interrupt.

In yet another exemplary embodiment, the non-volatile memory is connected to the buffer queue memory by a wide bus.

These and other features and advantages of the present invention will be described in, or will become apparent to those of ordinary skill in the art in view of, the following detailed description of the exemplary embodiments of the present invention.

### BRIEF DESCRIPTION OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 depicts a pictorial representation of an exemplary distributed data processing system in which aspects of the illustrative embodiments may be implemented;

FIG. 2A is a block diagram depicting an exemplary storage enclosure in accordance with an illustrative embodiment;

FIG. 2B is a block diagram depicting a second exemplary storage enclosure in accordance with an illustrative embodiment;

FIG. 3 is a block diagram depicting a sector conversion device in accordance with an illustrative embodiment; and

FIG. 4 is a flowchart illustrating operation of a sector conversion device in accordance with an illustrative embodiment.

### DETAILED DESCRIPTION OF THE ILLUSTRATIVE EMBODIMENTS

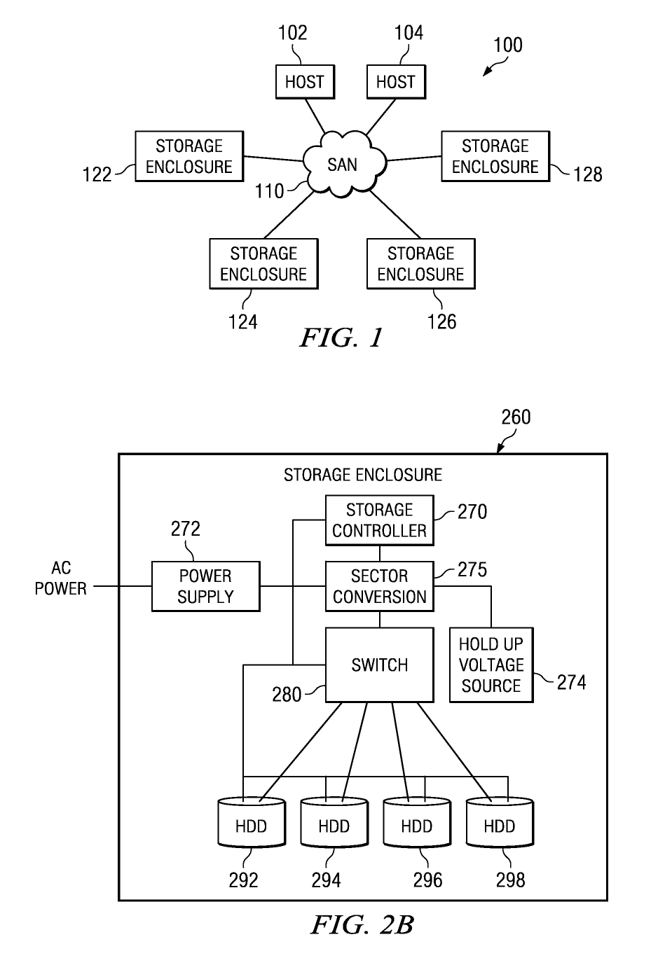

With reference now to the figures and in particular with reference to FIG. 1, an exemplary diagram of a data processing environment is provided in which illustrative embodiments of the present invention may be implemented. It should be appreciated that FIG. 1 is only exemplary and is not intended to assert nor imply any limitation with regard to the environments in which aspects or embodiments of the present invention may be implemented. Many modifications to the depicted environment may be made without departing from the spirit and scope of the present invention.

With reference now to the figures, FIG. 1 depicts a pictorial representation of an exemplary distributed data processing system in which aspects of the illustrative embodiments may be implemented. Distributed data processing system 100 may include a network of computers in which aspects of the illustrative embodiments may be implemented. The distributed data processing system 100 contains at least one storage area network (SAN) 110, which is the medium used to provide communication links between various devices and computers, such as host computers and storage enclosures, connected together within distributed data processing system 100. Storage area network 110 may include connections, such as wire, wireless communication links, serial attached small computer systems interface (serial attached SCSI or SAS) switches, or fiber optic cables.

In the depicted example, host computer 102 and host computer 104 are connected to storage area network (SAN) 110 along with storage enclosures 122, 124, 126, 128. A storage enclosure includes a storage controller and connection to one or more hard disk drives. The storage controller may be a simple controller for storing data to the hard disk drives, or alternatively may include a redundant array of independent disks (RAID) controller. Distributed data processing system 100 may include additional hosts, storage enclosures, clients, and other devices not shown.

In the depicted example, SAN 110 may use the Transmission Control Protocol/Internet Protocol (TCP/IP) suite of protocols to communicate with one another; however, more likely, SAN 110 may use a protocol associated with Fibre Channel (FC) or Serial attached SCSI (SAS). As stated above, FIG. 1 is intended as an example, not as an architectural limitation for different embodiments of the present invention, and therefore, the particular elements shown in FIG. 1 should not be considered limiting with regard to the environments in which the illustrative embodiments of the present invention may be implemented.

A storage system that supports disk drive technology that is fundamentally different from the system architecture requires some type of bridge function and sector conversion process. One such system is a Fibre Channel Arbitrated Loop (FC-AL) storage system that accommodates low cost Serial Advanced Technology Attachment (SATA) disk drives. One approach is to implement a global conversion process whereby a bridge module attaches to a number of FC-AL initiators (hosts) and also to a number of SATA disk drives. A second approach is to accomplish the bridge conversion process at a much lower level, such as the disk drive level.

The illustrative embodiments described herein provide a bridge device for each disk drive. These illustrative embodiments trade off simplicity for cost. That is, the bridge device only has to deal with a single I/O stream. The illustrative embodiments, however, may apply to either of the above approaches, but is especially suited for the latter approach because cost and real estate are prime areas of concern at the disk drive level.

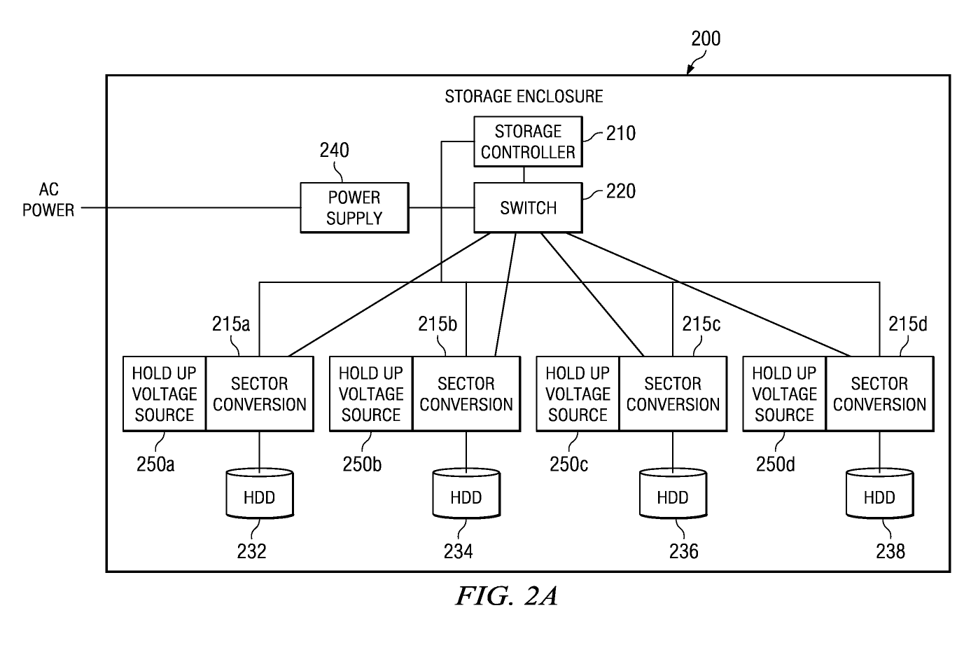

FIG. 2A is a block diagram depicting an exemplary storage enclosure in accordance with an illustrative embodiment. Storage enclosure 200 is comprised of storage controller 210, which may be a redundant array of independent disks (RAID) controller or a non-RAID controller. Storage controller 210 communicates with hard disk drives (HDDs) 232, 234, 236, and 238 through switch 220. Switch 220 may be, for example, a serial attached SCSI (SAS) switch. Other devices in a storage area network (SAN) may write data to or read data from storage enclosure 200 by connection to switch 220.

HDDs 232-238 must store data according to a sector size defined by the disk drive manufacturers. For example, a sector size of HDDs 232-238 may be 512 bytes. However, other devices in the SAN may append additional metadata to a sector's worth of data. For example, a device may append a cyclical redundancy checking (CRC) code to each sector, as well as other metadata. Therefore, storage enclosure 200 may receive data with a sector size from 512 bytes to 4 KB or more. Therefore, when data is persisted (written) to HDDs 232-238, the sector size must be converted to that of the HDDs. Sector conversion devices 215a-215d convert the sector size of incoming data being written to HDDs 232-238.

Power supply 240 receives alternating current (AC) power and provides direct current (DC) power to the components within storage enclosure 200. More particularly, power supply 240 provides DC power to storage controller 210, sector conversion devices 215a-215d, switch 220, and HDDs 232-238. If AC power to storage enclosure 200 is lost or interrupted, then there is a data integrity exposure within sector conversion devices 215a-215d.

In accordance with an illustrative embodiment, each sector conversion device 215a-215d includes a buffer queue memory area that is used to save two sectors' worth of data. As part of the sector conversion process, the sector conversion device saves two sectors of data in the buffer queue as a working memory. This buffer queue memory may also be powered by a separate voltage boundary from hold up voltage sources 250a-250d, which are connected to sector conversion devices 215a-215d via an independent set of voltage pins. Hold up voltage sources 250a-250d may be coin cell batteries, super capacitors, or residual bulk decoupling capacitors, for example.

When AC power is lost to storage enclosure 200 during a scenario where data is being written to HDDs 232-238, which involves sector conversion, the internal processors of sector conversion devices 215a-215d initiate a transfer of data from the buffer queue memory to a non-volatile memory and quiesces (stops) all subsequent write activity. Hold up voltage sources 250a-250d enable the buffer queue memory contents to be retained. The non-volatile memory within the sector conversion device is connected to the main internal memory of the device by a special link that is wider than the normal word size of the buffer. Because of the width of the special link, the transfer is very fast, which reduces or altogether eliminates any special hold-up capacitance requirements.

FIG. 2B is a block diagram depicting a second exemplary storage enclosure in accordance with an illustrative embodiment. Storage enclosure 260 is comprised of storage controller 270, which may be a redundant array of independent disks (RAID) controller or a non-RAID controller. Storage controller 270 communicates with hard disk drives (HDDs) 292, 294, 296, and 298 through switch 280. Switch 280 may be, for example, a serial attached SCSI (SAS) switch. Other devices in a storage area network (SAN) may write data to or read data from storage enclosure 260 by connection to switch 280.

HDDs 292-298 must store data according to a sector size defined by the disk drive manufacturers. For example, a sector size of HDDs 292-298 may be 512 bytes. However, other devices in the SAN may append additional metadata to a sector's worth of data. For example, a device may append a cyclical redundancy checking (CRC) code to each sector, as well as other metadata. Therefore, storage enclosure 260 may receive data with a sector size from 512 bytes to 4 KB or more. Therefore, when data is persisted (written) to HDDs 292-298, the sector size must be converted to that of HDDs 292-298.

Sector conversion device 275 converts the sector size of incoming data being written to HDDs 292-298. Sector conversion device 275 may be within storage controller 270 or may be an external component between storage controller 270 and HDDs 292-298.

Power supply 272 receives alternating current (AC) power and provides direct current (DC) power to the components within storage enclosure 260. More particularly, power supply 272 provides DC power to storage controller 270, sector conversion device 275, switch 280, and HDDs 292-298. If AC power to storage enclosure 260 is lost or interrupted, then there is a data integrity exposure within sector conversion device 275.

In accordance with an illustrative embodiment, sector conversion device 275 includes a buffer queue memory area that is used to save two sector's worth of data. As part of the sector conversion process, the sector conversion device saves two sectors of data in the buffer queue as a working memory. This buffer queue memory may also be powered by a separate voltage boundary from hold up voltage source 274, which is connected to sector conversion device 275 via an independent set of voltage pins. Hold up voltage source 274 may be a coin cell battery, super capacitor, or a residual bulk decoupling capacitor, for example.

When AC power is lost to storage enclosure 260 during a scenario where data is being written to HDDs 292-298, which involves sector conversion, the internal processor of sector conversion device 275 initiates a transfer of data from the buffer queue memory to a non-volatile memory and quiesces (stops) all subsequent write activity. Hold up voltage source 274 enables the buffer queue memory contents to be retained. The non-volatile memory within the sector conversion device is connected to the main internal memory of the device by a special link that is wider than the normal word size of the buffer. Because of the width of the special link, the transfer is very fast, which reduces or altogether eliminates any special hold-up capacitance requirements.

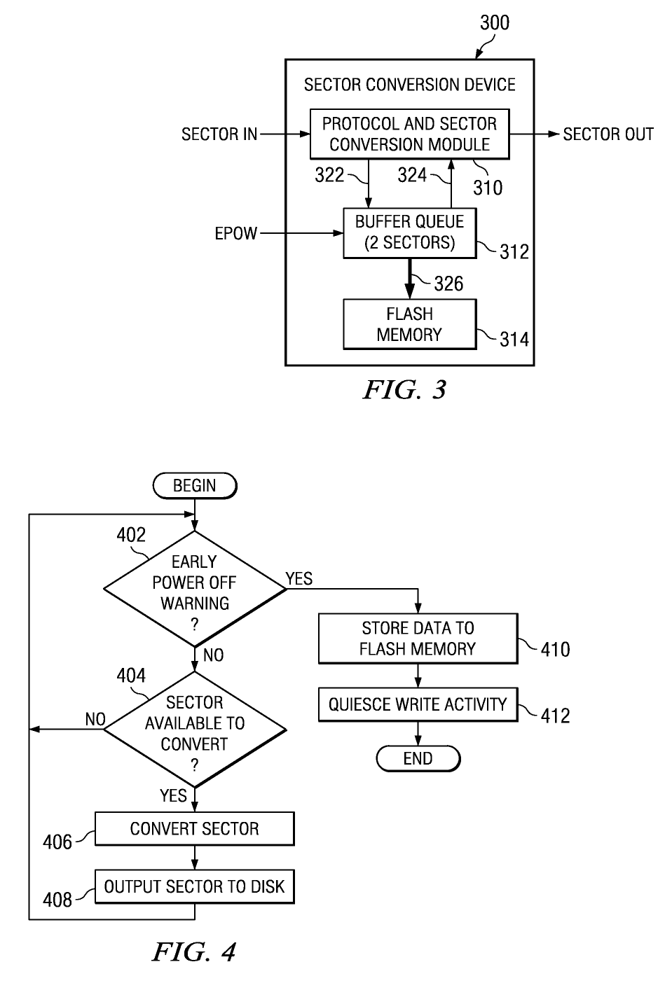

FIG. 3 is a block diagram depicting a sector conversion device in accordance with an illustrative embodiment. Sector conversion device 300 may be an application specific integrated circuit (ASIC), for example. Sector conversion device 300 includes buffer queue 312, protocol and sector conversion module 310, and flash memory 314. Protocol and sector conversion module 310 receives sectors, buffers them in buffer queue 312, converts them to the sector size of the hard disk drives, and outputs the converted sectors. For example, protocol and sector conversion module 310 may convert Fibre Channel arbitrated loop (FC-AL) data to a Serial Advanced Technology Attachment (SATA) sector size. Protocol and sector conversion module 310 may be an internal processor, for example.

In one exemplary embodiment, buffer queue 312 may be a volatile memory, such as a static random access memory (SRAM), that stores two sectors at a time. Protocol and sector conversion module 310 stores sector data through bus 322 and retrieves sector data through bus 324. Buses 322 and 324 may be of a normal data width, such as 32 bits or 64 bits. Protocol and sector conversion module 310 and buffer queue 312 may be powered by a main voltage source. The main voltage source may provide an early power off warning (EPOW) when AC power is lost or interrupted. The EPOW is an interrupt or message from the power supply that all the input (AC) power has been lost. After the EPOW, the main voltage source may provide power to sector conversion device 300 for a limited amount of time.

Logic within buffer queue module 312 receives the EPOW. The EPOW may trigger a state machine associated with buffer queue 312 and flash memory 314 to accomplish the transfer. Thus, when the main voltage source notifies buffer queue 312 of a power loss event, buffer queue 312 initiates a transfer of an appropriate amount of sector data to flash memory 314. In one exemplary embodiment, this amount of data is two sectors, one sector that is “in flight” to the hard disk drive(s) and a subsequent sector that is in flight. Flash memory 314 may be any non-volatile memory. Sector conversion device 300 may also be powered by a hold-up voltage source, which provides a separate voltage boundary. The hold-up voltage source may be a coin cell battery, a super capacitor, or a residual bulk decoupling capacitor, for example.

Flash memory 314 is connected to buffer queue 312 by bus 326. In one exemplary embodiment, bus 326 may be a special link that is wider than the normal “word” size of buffer queue 312. For example, bus 326 may be 1 k bits wide. Because of the width of bus 326, the transfer is very fast, which reduces or altogether eliminates the need for a special hold up voltage source.

FIG. 4 is a flowchart illustrating operation of a sector conversion device in accordance with an illustrative embodiment. It will be understood that each block of the flowchart illustration, and combinations of blocks in the flowchart illustration, can be implemented by computer program instructions. These computer program instructions may be provided to a processor, such as protocol and sector conversion module 310 in FIG. 3, or other programmable data processing apparatus to produce a machine, such that the instructions which execute on the processor or other programmable data processing apparatus create means for implementing the functions specified in the flowchart block or blocks. These computer program instructions may also be stored as firmware or software in a computer-readable memory or storage medium that can direct a processor or other programmable data processing apparatus to function in a particular manner, such that the instructions stored in the computer-readable memory or storage medium produce an article of manufacture including instruction means which implement the functions specified in the flowchart block or blocks.

Accordingly, blocks of the flowchart illustration support combinations of means for performing the specified functions, combinations of steps for performing the specified functions and program instruction means for performing the specified functions. It will also be understood that each block of the flowchart illustration, and combinations of blocks in the flowchart illustration, can be implemented by special purpose hardware-based computer systems, such as application specific integrated circuits (ASICs), which perform the specified functions or steps, or by combinations of special purpose hardware and computer instructions.

With reference now to FIG. 4, operation begins and the sector conversion device determines whether an early power off warning is received (block 402). If an early power off warning is not received, the sector conversion device determines whether a sector is available to be converted (block 404). If a sector is not available to be converted, operation returns to block 402 to determine whether an early power off warning is received.

If a sector is available to be converted in block 404, the sector conversion device converts the sector to the sector size of the hard disk drive(s) (block 406). Then, the sector conversion device outputs the sector to disk (block 408). Thereafter, operation returns to block 402 to determine whether an early power off warning is received.

Returning to block 402, if an early power off warning is received, the sector conversion device initiates a transfer of an appropriate amount of sector data from the buffer queue to flash memory within the sector conversion device (block 410). Thereafter, the sector conversion device quiesces write activity (block 412), and operation ends. In one exemplary embodiment, the amount of sector data is two sectors. In an exemplary embodiment, the flash memory is connected to the buffer queue memory by a special link that is wider than the normal “word” size of the buffer queue. Because of the width of the special link, the transfer is very fast, which reduces or altogether eliminates the need for a special hold up voltage source.

Thus, the illustrative embodiments solve the disadvantages of the prior art by providing a sector conversion device that includes a non-volatile memory area that is used to save two sectors' worth of data when power is lost during the sector conversion process. As part of the sector conversion process, the sector conversion device transfers two sectors of data from a volatile buffer queue memory to a non-volatile memory when a power loss event occurs. These two sectors of data are stored in the non-volatile memory area within the sector conversion device itself. The non-volatile memory within the sector conversion device is connected to the main internal memory of the device by a special link that is wider than the normal word size of the buffer.

When AC power is lost to the storage enclosure during a scenario where data is being written to the hard disk drives, which involves sector conversion, the internal processor of the sector conversion device immediately initiates a transfer from the volatile buffer queue memory to the non-volatile memory and quiesces all subsequent write activity. The information that is transferred (hardened) is the two sectors of data that were involved in the sector conversion process. Because of the width of the special link, the transfer is very fast, which reduces or altogether eliminates any special hold-up capacitance requirements.

The illustrative embodiments have minimum hold up capacity requirement due to low power requirements of the internal memory cells. The illustrative embodiments also save time because the save processes are all internal. In other words, there is little danger of the internal processor of the sector conversion device not being able to store the sector data in the sector memory, because the sector memory is internal to the device, rather than having to go through an interface to an external memory. Furthermore, the illustrative embodiments have reduced complexity relative to prior art solutions, because the illustrative embodiments do not require an interface to external memory devices. The illustrative embodiments also have a reduced cost, because there are no external memory interfaces or external non-volatile memory devices.

It should be appreciated that the illustrative embodiments may take the form of an entirely hardware embodiment, an entirely software embodiment or an embodiment containing both hardware and software elements. In one exemplary embodiment, the mechanisms of the illustrative embodiments are implemented in software, which includes but is not limited to firmware, resident software, microcode, etc.

Furthermore, the illustrative embodiments may take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

The medium may be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read-only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer program product comprising a computer useable medium having a computer readable program, wherein the computer readable program, when executed on a computing device, causes a sector conversion device to:
receive sector data; and
responsive to a power loss event from a voltage source, initiate a transfer of an amount of the received sector data from a buffer queue memory to a non-volatile memory that is internal to the sector conversion device.

2. The computer program product of claim 1, wherein the amount of the received sector data is two sectors.

3. The computer program product of claim 1, wherein the power loss event is an early power off warning.

4. The computer program product of claim 1, wherein the computer readable program, when executed on the computing device, further causes the sector conversion device to:
convert the sector data to a sector size of at least one hard disk drive to form converted sector data; and
output the converted sector data to at least one hard disk drive.

5. The computer program product of claim 1, wherein the non-volatile memory is connected to the buffer queue memory by a wide bus.

6. A sector conversion device, comprising:
a processor;
a buffer queue memory; and
a non-volatile memory,
wherein the processor receives sector data and stores the received sector data into the buffer queue memory; and
wherein responsive to a power loss event from a voltage source, the processor initiates a transfer of an amount of the received sector data from the buffer queue memory to the non-volatile memory.

7. The sector conversion device of claim 6, wherein the buffer queue memory is a volatile memory.

8. The sector conversion device of claim 6, wherein the amount of sector data is two sectors.

9. The sector conversion device of claim 6, wherein the non-volatile memory is connected to the buffer queue memory by a wide bus.

10. The sector conversion device of claim 6, wherein the power loss event is an early power off warning.

11. The sector conversion device of claim 10, wherein the early power off warning is an interrupt.

12. The sector conversion device of claim 6, wherein the sector conversion device is an application specific integrated circuit.

13. The sector conversion device of claim 6, wherein the processor converts the sector data to a sector size of at least one hard disk drive to form converted sector data and outputs the converted sector data to the at least one hard disk drive.

14. The sector conversion device of claim 6, wherein the sector conversion device is associated with a storage controller;
wherein the processor receives sector data from the storage controller;
wherein the processor converts the sector data from a first sector size to a second sector size to form converted sector data; and
wherein the processor sends the converted sector data to a switch to be written to one of a plurality of hard disk drives.

15. The sector conversion device of claim 6, wherein the sector conversion device is associated with a hard disk drive;
wherein the processor receives sector data from a switch;
wherein the processor converts the sector data from a first sector size to a second sector size to form converted sector data; and
wherein the processor sends the converted sector data to the hard disk drive.

16. A method for internal sector storage in a sector conversion device, the method comprising:
receiving sector data;
converting the sector data to a sector size of at least one hard disk drive to form converted sector data;
outputting the converted sector data to the at least one hard disk drive; and
responsive to a power loss event from a main voltage source, initiating transfer of an amount of the received sector data from a buffer queue to a non-volatile memory that is internal to the sector conversion device.

17. The method of claim 16, wherein the amount of the received sector data is two sectors.

18. The method of claim 16, wherein the power loss event is an early power off warning.

19. The method of claim 18, wherein the early power off warning is an interrupt.

20. The method of claim 16, wherein the non-volatile memory is connected to the buffer queue memory by a wide bus.
